(19) United States
(12) Patent Application Publication
(10) Pub. No.: US 2025/0349087 A1
(43) Pub. Date: Nov. 13, 2025

(54) METHOD FOR DETECTING VIRTUAL EFFECT MOUNTING PLANE, DEVICE, AND STORAGE MEDIUM

(71) Applicants: Beijing Zitiao Network Technology Co., Ltd., Beijing (CN); Lemon Inc., Grand Cayman (KY)

(72) Inventors: Yongzhi XU, Beijing (CN); Peng WANG, Los Angeles, CA (US); Hengkai GUO, Beijing (CN)

(21) Appl. No.: 18/872,743

(22) PCT Filed: Jun. 2, 2023
(86) PCT No.: PCT/CN2023/098144

§ 371 Date: Dec. 6, 2024

(30) Foreign Application Priority Data
Jun. 29, 2022 (CN) 202210761378.8

(51) Int. Cl. G06T 19/00; G06T 7/12; G06T 7/536

(52) U.S. Cl. CPC G06T 19/006; G06T 7/12; G06T 7/536; G06T 2210/21

(57) ABSTRACT

Embodiments of the present disclosure provide a method for detecting a virtual effect mounting plane, an electronic device, and a storage medium, and the method includes: acquiring contour line segments, and obtaining corresponding edge corner points based on the contour line segments, in which the contour line segments represent a contour of an object in an image to be detected, and the edge corner points are intersection points between the contour line segments; generating at least two quadrilateral structural borders with the edge corner points, in which each of the structural borders represents a contour of a plane of an object in the image to be detected; and obtaining matching degrees of the structural borders through target vanishing points corresponding to the structural borders, and determining a target border based on the matching degrees.

### CROSS-REFERENCE TO RELATED APPLICATION

The present application claims the priority to Chinese patent application No. 202210761378.8, filed on Jun. 29, 2022, entitled “METHOD AND APPARATUS FOR DETECTING VIRTUAL EFFECT MOUNTING PLANE, DEVICE, AND STORAGE MEDIUM,” the entire disclosure of which is incorporated herein by reference as portion of the present application.

### TECHNICAL FIELD

Embodiments of the present disclosure relate to the field of image processing technology, and in particular to a method and an apparatus for detecting a virtual effect mounting plane, an electronic device, a computer-readable storage medium, a computer program product, and a computer program.

### BACKGROUND

At present, when a virtual effect is added to an image or a video, firstly, a mounting plane needs to be located, and then a virtual effect material is added to the mounting plane for displaying. In the related art, the mounting plane is typically determined based on gradient information of pixels in an image.

However, the method for detecting a mounting plane in the related art has the problems of low detection accuracy, poor robustness in different image scenarios, and the like.

### SUMMARY

Embodiments of the present disclosure provide a method and an apparatus for detecting a virtual effect mounting plane, an electronic device, a computer-readable storage medium, a computer program product, and a computer program.

In a first aspect, the embodiments of the present disclosure provide a method for detecting a virtual effect mounting plane, which includes:
acquiring contour line segments, and obtaining corresponding edge corner points based on the contour line segments, in which the contour line segments represent a contour of an object in an image to be detected, and the edge corner points are intersection points between the contour line segments; generating at least two quadrilateral structural borders with the edge corner points, in which each of the structural borders represents a contour of a plane of an object in the image to be detected; and obtaining matching degrees of the structural borders through target vanishing points corresponding to the structural borders, and determining a target border based on the matching degrees, in which an object plane corresponding to the target border is used for mounting a virtual effect, and each of the matching degrees represents a degree to which an object plane corresponding to a structural border is suitable for mounting a virtual effect.

In a second aspect, the embodiments of the present disclosure provide an apparatus for detecting a virtual effect mounting plane, which includes:
an acquisition module, configured to acquire contour line segments, and obtain corresponding edge corner points based on the contour line segments, in which the contour line segments represent a contour of an object in an image to be detected, and the edge corner points are intersection points between the contour line segments;
a generation module, configured to generate at least two quadrilateral structural borders with the edge corner points, in which each of the structural borders represents a contour of a plane of an object in the image to be detected; and
a detection module, configured to obtain matching degrees of the structural borders through target vanishing points corresponding to the structural borders, and determine a target border based on the matching degrees, in which an object plane corresponding to the target border is used for mounting a virtual effect, and each of the matching degrees represents a degree to which an object plane corresponding to a structural border is suitable for mounting a virtual effect.

In a third aspect, the embodiments of the present disclosure provide an electronic device, which includes:
a processor and a memory in communication connection with the processor;
the memory is configured to store computer-executable instructions; and
the processor is configured to execute the computer-executable instructions stored in the memory to implement the method for detecting a virtual effect mounting plane according to the first aspect or any embodiment in the first aspect.

In a fourth aspect, the embodiments of the present disclosure provide a computer-readable storage medium, which stores computer-executable instructions, and a processor, when executing the computer-executable instructions, implements the method for detecting a virtual effect mounting plane according to the first aspect or any embodiment in the first aspect.

In a fifth aspect, the embodiments of the present disclosure provide a computer program product, which includes a computer program, and the computer program, when executed by a processor, implements the method for detecting a virtual effect mounting plane according to the first aspect or any embodiment in the first aspect.

In a sixth aspect, the embodiments of the present disclosure provide a computer program, and the computer program, when executed by a processor, implements the method for detecting a virtual effect mounting plane according to the first aspect or any embodiment in the first aspect.

The embodiments of the present disclosure provide a method and an apparatus for detecting a virtual effect mounting plane, an electronic device, a computer-readable storage medium, a computer program product, and a computer program, and the method includes: acquiring contour line segments, and obtaining corresponding edge corner points based on the contour line segments, in which the contour line segments represent a contour of an object in an image to be detected, and the edge corner points are intersection points between the contour line segments; generating at least two quadrilateral structural borders with the edge corner points, in which each of the structural borders represents a contour of a plane of an object in the image to be detected; and obtaining matching degrees of the structural borders through target vanishing points corresponding to the structural borders, and determining a target border based on the matching degrees, in which an object plane corresponding to the target border is used for mounting a virtual effect, and each of the matching degrees represents a degree to which an object plane corresponding to a structural border is suitable for mounting a virtual effect.

### BRIEF DESCRIPTION OF DRAWINGS

In order to more clearly illustrate the technical solutions of the embodiments of the present disclosure, the drawings that need to be used in description of the embodiments will be briefly described in the following. Apparently, the drawings in the following description are only some embodiments of the present disclosure. For those skilled in the art, other drawings can also be obtained based on these drawings without any inventive work.

FIG. 1 is a schematic diagram illustrating an application scenario of a method for detecting a virtual effect mounting plane provided by the embodiments of the present disclosure;

FIG. 2 is a first schematic flowchart of a method for detecting a virtual effect mounting plane provided by the embodiments of the present disclosure;

FIG. 3 is a schematic diagram of contour line segments and edge corner points provided by the embodiments of the present disclosure;

FIG. 4 is a schematic diagram of a clustering fusion process provided by the embodiments of the present disclosure;

FIG. 5 is a schematic diagram of generating a structural border based on an edge-corner structure combination provided by the embodiments of the present disclosure;

FIG. 6 is a second schematic flowchart of a method for detecting a virtual effect mounting plane provided by the embodiments of the present disclosure;

FIG. 7 is a schematic diagram of a target edge-corner structure including one edge-corner structure;

FIG. 8 is a schematic diagram of a target edge-corner structure including two edge-corner structures;

FIG. 9 is a schematic diagram of a visual included angle provided by the embodiments of the present disclosure;

FIG. 10 is a structural block diagram of an apparatus for detecting a virtual effect mounting plane provided by the embodiments of the present disclosure;

FIG. 11 is a schematic structural diagram of an electronic device provided by the embodiments of the present disclosure; and

FIG. 12 is a schematic diagram of a hardware structure of an electronic device provided by the embodiments of the present disclosure.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the disclosure.

An application scenario of the embodiments of the present disclosure is explained below.

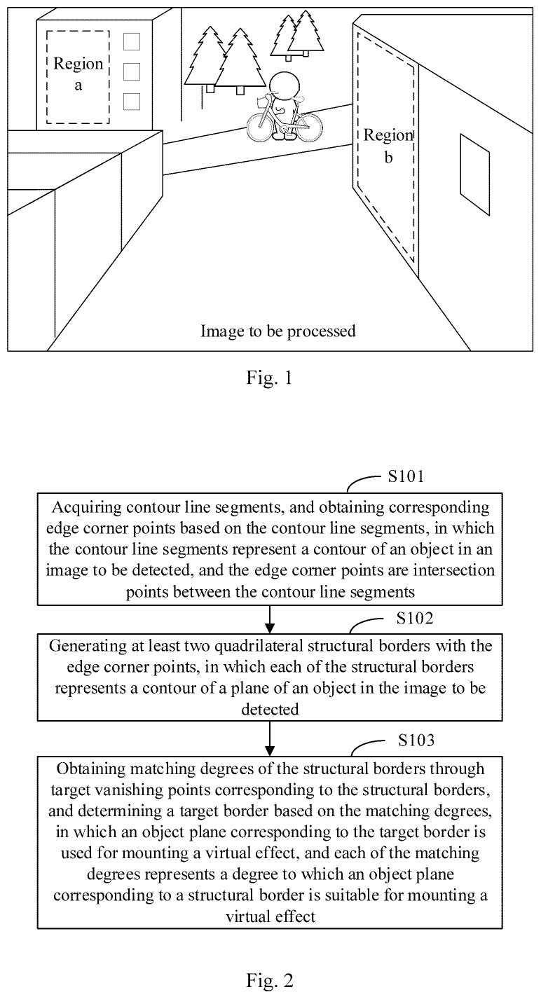

The method for detecting a virtual effect mounting plane provided by the embodiments of the present disclosure may be applied to an application scenario of adding virtual effects to videos or images in various applications. More specifically, for example, advertising information, virtual props, and the like are dynamically inserted to a video (various frames in the video). FIG. 1 is a schematic diagram illustrating an application scenario of a method for detecting a virtual effect mounting plane provided by the embodiments of the present disclosure. As shown in FIG. 1, by the method for detecting a virtual effect mounting plane provided by the embodiments of the present disclosure, mounting positions (shown as region a and region b in the figure) available for mounting “advertising information” on a surface of each object in an image to be processed (e.g., a wall in the image) may be detected. Corresponding virtual effects of the “advertising information” may be then mounted to the corresponding mounting positions, respectively. In this way, the purpose of dynamically inserting the advertising information in an image or a video is achieved. In addition to the advertising information, in other specific application scenarios, after the mounting positions are determined, other virtual effects, such as people photos and virtual props, may also be mounted. A similar effect may be achieved, which will not be described here redundantly.

In the above-mentioned application scenario, when a virtual effect such as “advertising information” is inserted into an image, it needs to be avoided that the inserted virtual effect affects normal showing of the image, and inharmony of the virtual effect and the image content also needs to be avoided. Therefore, firstly, a mounting position corresponding to the virtual effect needs to be determined. For example, the “advertising information” is mounted on a “wall” or an “external facade of a building” in an image such that visual consistency with the image content and the authenticity of the image after mounting are achieved. In the related art, the mounting plane is typically determined based on gradient information of pixels in an image. Specifically, line segments are extracted based on the gradient information between the pixels in the image, and then a structural border representing the mounting plane is determined based on a positional relationship between the line segments. However, the extraction of such line segments is purely based on the gradient information of gray levels of pixels, and there is no any semantic information, leading to usually incomplete lengths of the line segments and inaccurate endpoints of the line segments. The robustness of the structural border detected based on the line segments in the related art is poor, rules are complex, and the speed is low. Moreover, because the visual shape of the mounting plane in the image is affected by a capturing angle of a camera and a content captured (referring to FIG. 1, a mounting plane directly facing a capturing center point of the camera is rectangular, and a mounting plane obliquely facing the capturing center point of the camera may be trapezoidal), which is complicated and may be hardly marked in a large quantity, only objects in the image may be detected by universal object detection based on deep learning to generate a two-dimensional rectangular box for describing the position of the image. However, it is difficult to realize the detection of the mounting plane.

Therefore, in conclusion, due to the particularity of the mounting plane, the detection of the mounting plane in the image in the related art has the problems of low detection accuracy, poor robustness, and the like.

The embodiments of the present disclosure provide a method for detecting a virtual effect mounting plane. Structural features of an object in an image are extracted by detecting edge corner points in the image, and structural borders representing contours of object planes are generated. Based on the characteristic that a vanishing point is capable of representing a capturing angle of the image, the structural borders are screened through the vanishing point to determine the object plane suitable for mounting a virtual effect. Thus, the above-mentioned problems can be solved.

With reference to FIG. 2, FIG. 2 is a first schematic flowchart of a method for detecting a virtual effect mounting plane provided by the embodiments of the present disclosure. The method of this embodiment may be applied to an electronic device such as a terminal device or a server. The method for detecting a virtual effect mounting plane includes the steps described below.

Step S101: acquiring contour line segments, and obtaining corresponding edge corner points based on the contour line segments, in which the contour line segments represent a contour of an object in an image to be detected, and the edge corner points are intersection points between the contour line segments;

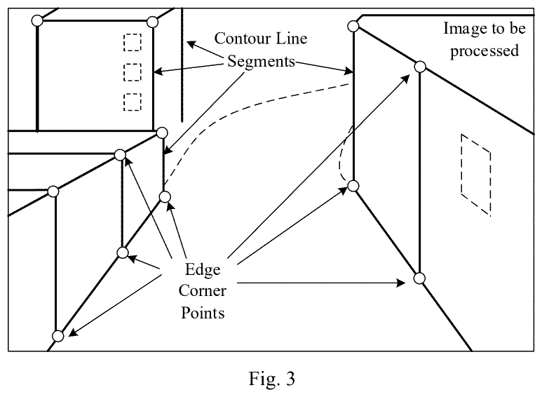

Exemplarily, the contour line segments are all straight line segments representing a contour of an object in an image to be processed obtained after detecting a target image. Usually, there are a plurality of contour line segments. According to a specific object structure, the contour line segments may have the same or different extension directions. Part of the contour line segments may intersect, and corner points at which the contour line segments intersect with each other are the edge corner points. FIG. 3 is a schematic diagram of contour line segments and edge corner points provided by the embodiments of the present disclosure. As shown in FIG. 3, the image may be a video frame. After the video frame is detected, a plurality of line segments representing a contour of a building, i.e., the contour line segments, are obtained. Based on a specific identification result, the contour line segments may be all or part of line segments constituting an object (e.g., the building in the figure). Further, intersection points, i.e., the edge corner points, between the contour line segments can be determine according to the positional relationship between the contour line segments. The edge corner points are determined from intersection relationship of the contour line segments representing the object contour and thus can represent the structural features of the object. The process of obtaining the contour line segments by detecting the image to be processed may be achieved by identifying line segments in the image to be processed using a pre-trained neural network model. The specific obtaining manner is not described redundantly here.

In some optional cases, endpoints of two contour line segments intersect and coincide at one point (i.e., two contour line segments constituting “L” shape). In this case, the edge corner point is the endpoint coinciding point of the two contour line segments. More specifically, that endpoints of two contour line segments intersect and coincide at one point refers to a distance between coordinates corresponding to the endpoints of the two contour line segments is smaller than a preset threshold, which will not be described redundantly here. In some other optional cases, an endpoint of one contour line segment intersects with the middle of the other contour line segment (i.e., two contour line segments constituting “T” shape). In this case, the endpoint intersecting the middle of the contour line segment is the edge corner point. In yet another optional cases, two contour line segments may be arranged such that the middles of the line segments intersect (i.e., two contour line segments constituting “X” shape). In this case, the two contour line segments have no edge corner point.

Exemplarily, after the edge corner points are obtained, for some contour line segments close to one another, the distances between the formed corresponding edge corner points are small, and more effective structural information of the object may not be increased. Meanwhile, when a structural border representing a contour of an object plane is subsequently generated based on the edge corner points, if the area of the structural border is too small (due to too dense edge corner points), it cannot be used for indicating a mounting plane for mounting a virtual effect. Therefore, the edge corner points may be fused to reduce the number of the edge corner points. An ineffective detection process is reduced and an overall detection speed is increased. Specifically, the step of obtaining the corresponding edge corner points based on the contour line segments in step S101 includes:
step S1011: obtaining at least two intersection corner points according to intersection relationships of the contour line segments; and
step S1012: performing clustering fusion on the intersection corner points based on a density clustering algorithm to generate the edge corner points.

Exemplarily, the intersection relationships of the contour line segments may be determined by an intersection detection algorithm between line segments, and the specific implementation method is the related art and will not be described redundantly. Then, the intersection corner points are merged based on the density clustering algorithm such that neighboring intersection corner points are merged into the same corner point, e.g., the edge corner point. The density clustering is also known as density-based clustering. Such the algorithm assumes that a clustering structure can be determined from a compact degree of sample distribution. Under usual cases, the density clustering algorithm is to investigate connectability between samples from the perspective of sample density, and to continuously expand a cluster based on connectable samples to obtain a final clustering result. The specific implementation method of density clustering will not be described redundantly.

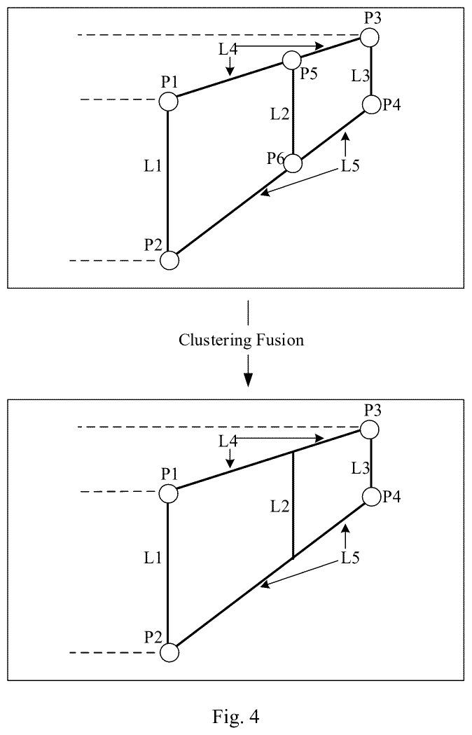

Clustering fusion is performed on the intersection corner points based on the density clustering algorithm, and only the edge corner points formed by the endpoints of two contour line segments intersecting and coinciding at one point (e.g., the edge corner points corresponding to two contour line segments of “L” shape) are retained. FIG. 4 is a schematic diagram of a clustering fusion process provided by the embodiments of the present disclosure. As shown in FIGS. 4, L1, L2, L3, L4, and L5 are 5 contour line segments in the image to be processed, and 6 intersection corner points P1, P2, P3, P4, P5, and P6 can be obtained according to the intersection relationships between the 5 contour line segments. Subsequently, after clustering fusion, P1, P2, P3, and P4 are determined as the edge corner points, and the intersection corner points P5 and P6 in the middles are not used as the edge corner points. Thus, when a structural border is subsequently determined with the edge corner points, it may be avoided that an invalid structural border having a too small area is generated. As a result, the detection efficiency of the mounting plane can be improved.

Step S102: generating at least two quadrilateral structural borders with the edge corner points, in which each of the structural borders represents a contour of a plane of an object in the image to be detected.

Exemplarily, after the edge corner points are obtained, because the edge corner point is generated based on two intersecting contour line segments, each edge corner point corresponds to two line segments. An enclosed quadrilateral, i.e., the structural border, may be constructed based on the positional relationship between the contour line segments corresponding to one or more edge corner points. Because the edge corner points can represent the structural features of the object, the quadrilateral structural border constructed based on the edge corner points can represent the contour of one plane of the object in the image to be detected. Specifically, for example, each edge corner point may be traversed orderly, and two contour line segments corresponding to the edge corner point construct the “L-shaped” structure, which is combined with the “L-shaped” structure constructed by two contour line segments corresponding to another edge corner point. At least two edge corner points capable of constituting an enclosed quadrilateral are detected to generate the structural border.

In an optional embodiment, step S102 includes the following implementation steps:
step S1021: acquiring edge-corner structures corresponding to the edge corner points, in which each of the edge-corner structures includes two contour line segments constituting an edge corner point;
step S1022: obtaining at least one edge-corner structure combination according to a positional relationship between the edge-corner structures corresponding to the edge corner points, in which the edge-corner structure combination includes at least one edge-corner structure, the at least one edge-corner structure in the edge-corner structure combination belongs to a same quadrilateral, and in response to the edge-corner structure combination including more than two edge-corner structures, at least one contour line segment of any edge-corner structure in the edge-corner structure combination partially overlaps with another edge-corner structure; and step S1023: generating the structural borders according to the edge-corner structure combination.

Exemplarily, the edge-corner structure refers to two contour line segments of “L” shape corresponding to the edge corner point. The edge-corner structures corresponding to the edge corner points may be different in length and direction. Therefore, the edge-corner structures corresponding to the edge corner points may be arranged such that endpoints intersect and line segments coincide to form a quadrilateral. In a possible implementation, before the possible combinations of the edge-corner structures are traversed, the validity of the edge-corner structures is detected first.

Specifically, for example, whether the edge-corner structure is a valid edge-corner structure by at least one of the following conditions:
condition 1: two contour line segments of the edge-corner structure belong to valid vanishing points, and two vanishing points are different;
condition 2: a two-dimensional angle and a three-dimensional angle between two contour line segments of the edge-corner structure are both greater than corresponding preset thresholds; and
condition 3: the lengths of two contour line segments of the edge-corner structure are within a present range.

The validity detection on the edge-corner structure may be implemented by at least one of the above-mentioned three conditions. The three-dimensional angle between two contour line segments may be obtained by performing normalization calculation on a preset camera focal length parameter on the basis of the two-dimensional angle, which will not be specifically described. By the above-mentioned process of performing the validity detection on the edge-corner structure, an invalid edge-corner structure may be removed. Thus, the time taken to traverse the combination of the edge-corner structures to generate an edge-corner structure combination is reduced, and the detection efficiency can be improved.

Because the edge corner point can represent the structural feature of the object, if the edge corner point is served as a vertex angle of the contour of one plane of the object in the image to be processed, the corresponding edge-corner structure is two edges of the contour of one plane of the object in the image to be processed. Further, based on the edge-corner structure combination composed of a plurality of edge-corner structures, in response to determining that the plurality of edge-corner structures in the edge-corner structure combination belong to the same quadrilateral and part of line segments of the edge-corner structures coincide or endpoints coincide, an attempt may be made to generate the structural borders based on the edge-corner structure combination. More specifically, whether the edge-corner structures in the edge-corner structure combination can generate the structural borders may be determined based on whether the contour line segments of the edge-corner structures belong to two vanishing points (i.e., a horizontal vanishing point and a vertical vanishing point).

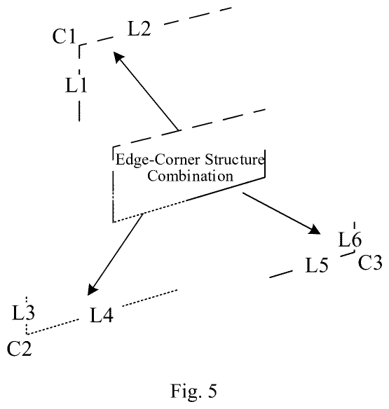

FIG. 5 is a schematic diagram of generating a structural border based on an edge-corner structure combination provided by the embodiments of the present disclosure. As shown in FIG. 5, the edge-corner structure combination includes edge-corner structures C1, C2, and C3, C1 includes contour line segments L1 and L2, C2 includes contour line segments L3 and L4, and C3 includes contour line segments L5 and L6. All the edge-corner structures are traversed, and after the edge-corner structure combination composed of C1, C2, and C3 is found, one quadrilateral structural border may be determined based on C1, C2, and C3. In the present embodiment, traversal is performed based on the positional relationship between the edge-corner structures corresponding to the edge corner points, and a matching edge-corner structure combination is obtained, and the structural border is thus generated. With the structural features of the object, accurate positioning of the object plane in the image to be processed is realized, and the detection accuracy of the finally determined mounting plane is improved.

Step S103: obtaining matching degrees of the structural borders through target vanishing points corresponding to the structural borders, and determining a target border based on the matching degrees, in which an object plane corresponding to the target border is used for mounting a virtual effect, and each of the matching degrees represents a degree to which an object plane corresponding to a structural border is suitable for mounting a virtual effect.

Exemplarily, after the structural border is determined, a corresponding object plane may be determined according to the position of the structural border in the image to be processed. Usually, there are a plurality of structural borders obtained by the above-mentioned steps, which thus correspond to a plurality of object planes in the image to be processed. However, for a particular scenario for mounting a virtual effect, not all the object planes are suitable for mounting the virtual effect. For example, some object planes may have a too small area, or the showing angle of an object plane in the image may be too small, and so on. Therefore, the structural borders need to be further screened to determine the corresponding object plane suitable for mounting the virtual effect.

Specifically, the matching degree of the structural border is evaluated with the target vanishing point corresponding to the structural border, and the matching degree represents a degree to which the object plane corresponding to the structural border is suitable for mounting the virtual effect. Specifically, the matching degree may be implemented by a particular normalization score. For example, 1 is the highest, i.e., it represents the most suitability for mounting the virtual effect; and 0 is the lowest, i.e., it represents the least suitability for mounting the virtual effect. The matching degree corresponding to the structural border is in a range of (0, 1). Based on the matching degree of the structural border, the structural edge of which the matching degree is greater than a matching threshold (e.g., 0.6) is determined as the target border. Alternatively, a preset number (e.g., 3) of structural borders having the greatest matching degree may be determined as the target borders, which may be particularly set as required.

Further, in an optional embodiment, the implementation step of obtaining the matching degrees of the structural borders through the target vanishing points corresponding to the structural borders includes:
step S1031: acquiring a first evaluation value of a structural border, in which the first evaluation value represents a total number of relevant line segments corresponding to a target vanishing point, and the relevant line segments are contour line segments belonging to the target vanishing point; and
step S1032: obtaining the matching degree of the structural border according to the first evaluation value.

Exemplarily, the vanishing point, also known as an extinction point, refers to an intersection point of projections of a set of parallel lines on a two-dimensional plane in three-dimensional space. Vanishing point detection on a single two-dimensional image refers to detecting intersection points of projection lines of N sets of three-dimensional spatial parallel lines included in the two-dimensional image as vanishing points. The quadrilateral structural border is constituted by the contour line segments corresponding to the edge corner points, and each contour line segment belongs to a unique vanishing point. Therefore, at least two vanishing points, i.e., target vanishing point, may be determined through the structural borders. Further, a vanishing point corresponds to a plurality of relevant line segments, and the relevant line segment is a contour line segment of which an extended line passes through the vanishing point in the image to be processed. The target vanishing point in the step of this embodiment corresponds to the relevant line segments. The more the relevant line segments corresponding to the target vanishing point, the more the extended lines of the contour line segments that pass through the target vanishing point, and the higher the accuracy of the target vanishing point, i.e., the higher the first evaluation value.

Further, the accuracy of the structural border and the magnitude of the corresponding first evaluation value of the target vanishing point are in the following corresponding relationship: specifically, the greater the first evaluation value of the target vanishing point, the higher the accuracy of the target vanishing point, and the more accurate the contour line segments belonging to the target vanishing point can represent the object structure, and hence the higher the accuracy of the corresponding structural border. Therefore, the matching degree of the structural border is evaluated with the first evaluation value of the target vanishing point. The greater the first evaluation value, the higher the matching degree. Thus, the structural border is evaluated from the perspective of accuracy, and one or more structural borders having the highest accuracy are obtained as the target borders. Accordingly, the accuracy of detecting the mounting plane is improved.

In the present embodiment, the contour line segments are acquired, and the corresponding edge corner points are obtained based on the contour line segments, in which the contour line segments represent the contour of the object in the image to be detected, and the edge corner points are intersection points between the contour line segments. At least two quadrilateral structural borders are generated with the edge corner points, and the structural border represents the contour of one plane of the object in the image to be detected. The matching degree of each structural border is obtained through the target vanishing point corresponding to the structural border, and the target border is determined based on the matching degree, in which the object plane corresponding to the target border is used for mounting the virtual effect, and the matching degree represents the degree to which the object plane corresponding to the structural border is suitable for mounting the virtual effect. The structural borders are generated by detecting the edge corner points. The structural borders are screened with the vanishing points to determine the target border for locating the mounting plane. With the structural features of the object in the image in combination with the vanishing point, the obtained target border can accurately locate the object plane suitable for mounting the virtual effect in the image to be detected. Thus, the detection of the mounting plane is realized, and the detection accuracy of the mounting plane and the detection robustness in different image scenes are improved.

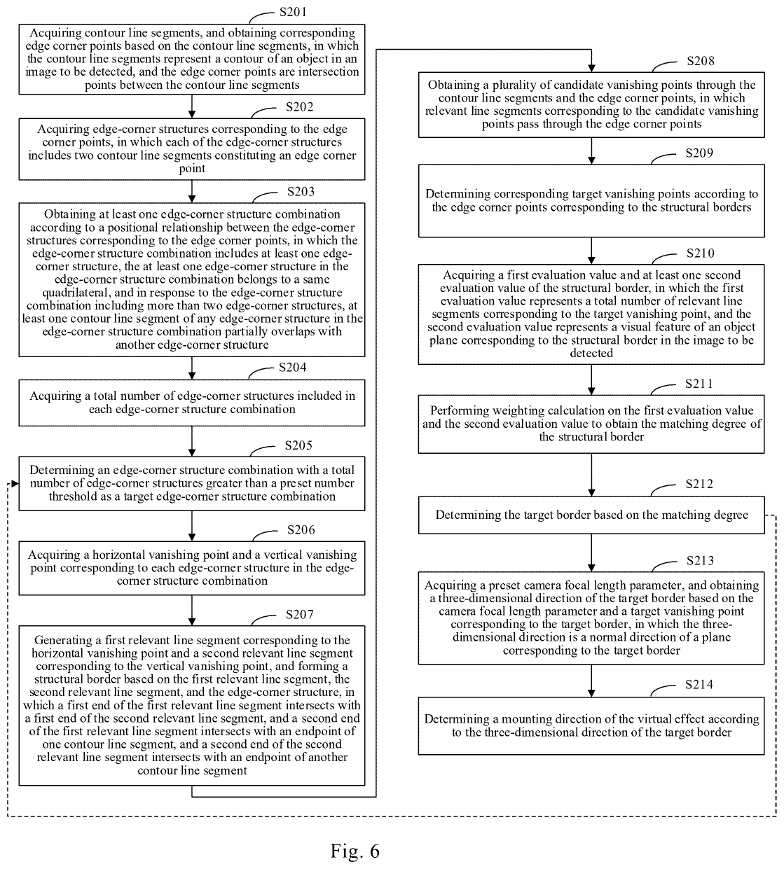

With reference to FIG. 6, FIG. 6 is a second schematic flowchart of a method for detecting a virtual effect mounting plane provided by the embodiments of the present disclosure. The present embodiment provides further detailed description on step S102 and step S103 on the basis of the embodiment shown in FIG. 2, and a step of determining a mounting direction of a virtual effect is added. The method for detecting a virtual effect mounting plane includes steps described below.

Step S201: acquiring contour line segments, and obtaining corresponding edge corner points based on the contour line segments, in which the contour line segments represent a contour of an object in an image to be detected, and the edge corner points are intersection points between the contour line segments.

Step S202: acquiring edge-corner structures corresponding to the edge corner points, in which each of the edge-corner structures includes two contour line segments constituting an edge corner point.

Step S203: obtaining at least one edge-corner structure combination according to a positional relationship between the edge-corner structures corresponding to the edge corner points, in which the edge-corner structure combination includes at least one edge-corner structure, the at least one edge-corner structure in the edge-corner structure combination belongs to a same quadrilateral, and in response to the edge-corner structure combination including more than two edge-corner structures, at least one contour line segment of any edge-corner structure in the edge-corner structure combination partially overlaps with another edge-corner structure.

Step S201 is the step of obtaining the contour line segments and the edge corner points, and steps S202-S203 are steps of obtaining the corresponding edge-corner structures based on the edge corner points and traversing the edge-corner structures to obtain the edge-corner structure combination. The above-mentioned steps have been described in the embodiment shown in FIG. 2, and a reference may be made to the detailed description in the foregoing embodiments, which will not be repeated here.

Step S204: acquiring a total number of edge-corner structures included in each edge-corner structure combination.

Step S205: determining an edge-corner structure combination with a total number of edge-corner structures greater than a preset number threshold as a target edge-corner structure combination.

Exemplarily, among the edge-corner structure combinations obtained in step S203, they may be classified as edge-corner structure combinations of different levels based on the number of edge-corner structures included therein. For example, the edge-corner structure combination includes only one “L-shaped” edge-corner structure, and thus is a first-level edge-corner structure combination; the edge-corner structure combination includes two “L-shaped” edge-corner structures, and thus is a second-level edge-corner structure combination; and so on. The edge-corner structure combination of a higher level includes more edge-corner structures, and correspondingly, the quadrilateral that can be determined is more accurate. An edge-corner structure combination including more edge-corner structures is selected based on the level (i.e., the number of edge-corner structures included in the edge-corner structure combination) of the edge-corner structure combination. For example, the edge-corner structure combination including more than two edge-corner structures is taken as the target edge-corner structure combination for subsequent processing. Reducing the number of the edge-corner structure combinations to be detected may further improve the detection efficiency and shorten the detection time of the mounting plane.

In an optional embodiment, as shown by the dotted line in FIG. 6, in the specific implementation of step S205, the levels of the edge-corner structure combinations (i.e., the numbers of edge-corner structures included in the edge-corner structure combinations) may be ranked. In a descending order, the edge-corner structure combination of the highest level (the greatest number of edge-corner structures) is preferably determined as the target edge-corner structure combination, and then the subsequent steps such as S206 and S207 are sequentially performed. Subsequent matching degree evaluation is performed. After the matching degree is evaluated as being accepted, a corresponding target border is generated (i.e., step S212), and then step S205 is performed again to determine the edge-corner structure combination of a lower level as the target edge-corner structure combination according to the ranking of levels for next round of processing, until the number of target borders meets a preset number. Thus, the overall detection efficiency is improved, and the purpose of rapidly locating the matching plane meeting the requirement is achieved.

Step S206: acquiring a horizontal vanishing point and a vertical vanishing point corresponding to each edge-corner structure in the edge-corner structure combination.

Step S207: generating a first relevant line segment corresponding to the horizontal vanishing point and a second relevant line segment corresponding to the vertical vanishing point, and forming a structural border based on the first relevant line segment, the second relevant line segment, and the edge-corner structure, in which a first end of the first relevant line segment intersects with a first end of the second relevant line segment, and a second end of the first relevant line segment intersects with an endpoint of one contour line segment, and a second end of the second relevant line segment intersects with an endpoint of another contour line segment.

Steps S206-S207 are the specific process of constructing the structural border based on the target edge-corner structure combination, which will be described in detail in different cases.

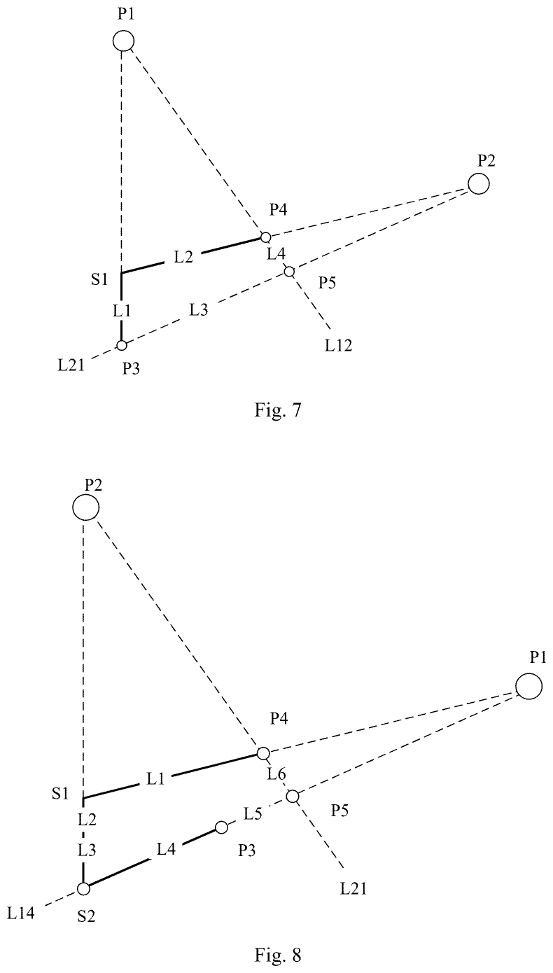

FIG. 7 is a schematic diagram of a target edge-corner structure including one edge-corner structure. As shown in FIG. 7, the target edge-corner structure includes edge-corner structure S1 which is constituted by contour line segments L1 and L2, i.e., the target edge-corner structure combination provides two edges of a quadrilateral. On this basis, vertical vanishing point P1 corresponding to L1 and horizontal vanishing point P2 corresponding to L2 are acquired. Then, with P1 and P2 as starting points, rays L12 and L21 are emanated towards open endpoints of L2 and L1 to form intersection points P3, P4, and P5, respectively, where P3 is the open endpoint of L1, P4 is the open endpoint of L2, and P5 is the intersection point of L12 and L21. Then, with P5 as the endpoint, line segments are emanated towards P3 and P4, respectively to generate new line segment L3 (i.e., the first relevant line segment) and L4 (i.e., the second line segment). Thus, the quadrilateral defined by L1, L2, L3, and L4 is generated, i.e., the structural border.

FIG. 8 is a schematic diagram of a target edge-corner structure including two edge-corner structures. With reference to FIG. 8, the target edge-corner structure includes edge-corner structures S1 and S2. S1 is constituted by contour line segments L1 and L2, and S2 is constituted by contour line segments L3 and L4, where L2 and L3 partially coincide, i.e., the target edge-corner structure combination provides three edges of a quadrilateral. On this basis, horizontal vanishing point P1 corresponding to L1 and vertical vanishing point P2 corresponding to L2 are acquired. Correspondingly, L3 corresponds to the vertical vanishing point P2, and L4 corresponds to the horizontal vanishing point P1. Then, with P1 and P2 as starting points, rays L14 and L21 are emanated towards open endpoints of L4 and L1 to form intersection points P3, P4, and P5, respectively, where P3 is the open endpoint of L4, P4 is the open endpoint of L1, and P5 is the intersection point of L14 and L21. Then, with P5 as the endpoint, line segments are emanated towards P3 and P4, respectively to generate new line segment L5 (i.e., the first relevant line segment) and L6 (i.e., the second line segment). Thus, the quadrilateral defined by L4+L5, L2+L3, L1, and L6 is generated, i.e., the structural border. L4 and L5 are located in the same straight line and partially coincide (coincide at endpoints); L2 and L3 are located in the same straight line and partially coincide; L4+L5 is a union set of L4 and L5; and L2+L3 is a union set of L2 and L3.

As can be known from the above-mentioned embodiments, in the process that the structural border is constructed with the target edge-corner structure combination, the more the edge-corner structures in the target edge-corner structure combination, the shorter the first relevant line segment and the second relevant line segment needing to be supplemented based on the vertical vanishing point and the horizontal vanishing point, i.e., the more the structural features of the real object in the image to be processed expressed, and hence the more accurate the detected mounting plane. Conversely, the fewer the edge-corner structures in the target edge-corner structure combination, the longer the first relevant line segment and the second relevant line segment needing to be supplemented based on the vertical vanishing point and the horizontal vanishing point, and correspondingly, the fewer the structural features of the real object in the image to be processed expressed, and hence the less accurate the detected mounting plane. Therefore, in the step of determining the target edge-corner structure combination, the accuracy of mounting plane detection can be improved by selecting the edge-corner structure combination including more edge-corner structures as the target edge-corner structure combination.

Step S208: obtaining a plurality of candidate vanishing points through the contour line segments and the edge corner points, in which relevant line segments corresponding to the candidate vanishing points pass through the edge corner points.

Step S209: determining corresponding target vanishing points according to the edge corner points corresponding to the structural borders.

Exemplarily, after the contour line segments and the edge corner points in the image to be processed are obtained by step S201, a plurality of vanishing points (i.e., the candidate vanishing points in the step of this embodiment) in the image to be processed can be detected based on the contour line segments and the corresponding edge corner points. Exemplarily, the candidate vanishing points include a horizontal candidate vanishing point and a vertical candidate vanishing point. The horizontal candidate vanishing point and the vertical candidate vanishing point may be obtained by detecting two contour line segments corresponding to each edge corner point. If the obtained horizontal candidate vanishing point and/or the vertical candidate vanishing point is/are real (i.e., the number of the relevant line segments of the vanishing point is greater than the number threshold), the generated horizontal candidate vanishing point and/or vertical candidate vanishing point pass through, for example, the edge corner point. Then, the corresponding target vanishing points can be determined according to the edge corner points corresponding to the structural borders obtained in the above-mentioned steps (the edge corner points corresponding to one structural border correspond to the same vanishing point). More specifically, the target vanishing points include a horizontal target vanishing point and a vertical target vanishing point.

In the present embodiment, the plurality of candidate vanishing points are obtained based on the contour line segments and the edge corner points, and other vanishing points unrelated to the edge corner points are ruled out by using the structural information of the object included in the edge corner points. Therefore, in subsequent detection process, the detection time is reduced and the detection efficiency is improved.

Step S210: acquiring a first evaluation value and at least one second evaluation value of the structural border, in which the first evaluation value represents a total number of relevant line segments corresponding to the target vanishing point, and the second evaluation value represents a visual feature of an object plane corresponding to the structural border in the image to be detected.

Exemplarily, after a plurality of structure borders are obtained, further, the structure borders are evaluated with the first evaluation value and at least one second evaluation value of each structural border to screen the object plane suitable for mounting the virtual effect. The specific implementation of the first evaluation value has been described in the embodiment shown in FIG. 2, which will not be described here redundantly. The second evaluation value is used to evaluate whether the object plane corresponding to the structural border is suitable for mounting the virtual effect based on the first evaluation value in further combination with the visual feature of the object plane corresponding to the structural border in the image to be detected. Specifically, the second evaluation value includes at least one selected from a group consisting of: a visual included angle, an image area, a total number of internal associated line segments, and a total number of internal conflicting line segments.

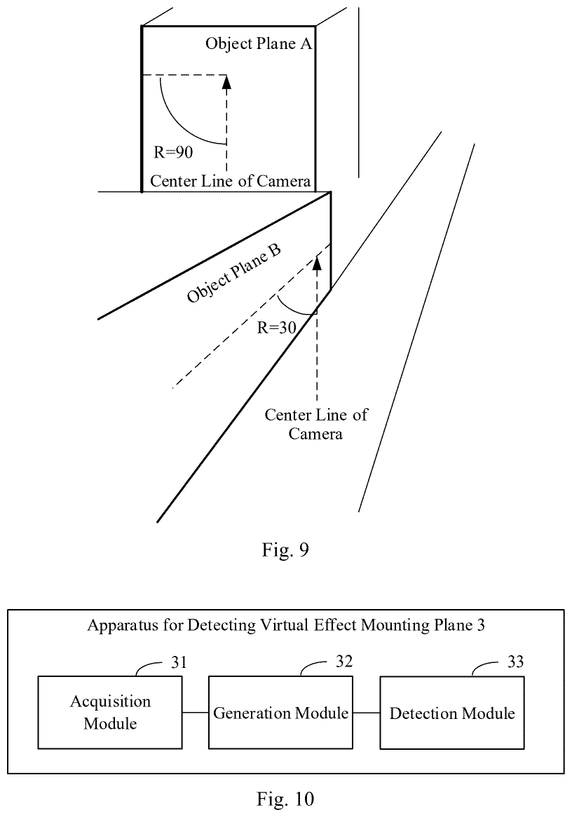

Exemplarily, the visual included angle is an included angle between the object plane corresponding to the structural border and a center line of a camera. FIG. 9 is a schematic diagram of a visual included angle provided by the embodiments of the present disclosure. The center line of the camera is a normal direction perpendicular to an image plane. The greater the included angle between the object plane and the center line of the camera (the maximum is 90 degrees), the more the object plane directly faces a viewing angle of a user, and then the better the showing effect, and the greater the second evaluation value. Conversely, the smaller the included angle between the object plane and the center line of the camera (the minimum is 0 degree), the more the object plane deviates from the viewing angle of the user, and hence the poorer the showing effect, and the less the second evaluation value. As shown in FIG. 9, taking the horizontal direction as an example, the visual included angle of object plane A is R=90 degrees, indicating that the object plane directly faces the camera and the showing effect is the best. In response to the visual included angle being R=30 degrees, the object plane laterally faces the camera and the showing effect is poor.

Exemplarily, the image area is an area of the object plane corresponding to the structural border in the image to be detected. The larger the image area, the better the showing effect, and the greater the second evaluation value, which will not be described here redundantly.

Exemplarily, the internal associated line segments are contour line segments located within the structural border and belonging to the target vanishing point corresponding to the structural border; and the internal conflicting line segments are contour line segments located within the structural border and not belonging to the target vanishing point corresponding to the structural border.

Specifically, the internal associated line segments and the internal conflicting line segments are all the line segments located within the structural border. In the application scenario of mounting a virtual effect such as advertising information in an image, in order to avoid the mounted virtual effect from affecting the content of the image itself, the virtual effect may be mounted in some regions without valid information, e.g., on a wall having a repeated texture. The internal associated line segments and the internal conflicting line segments are detected. If there are many internal associated line segments, i.e., if there are many contour line segments belonging to the same target vanishing point, it indicates that most of lines included in the object plane corresponding to the structural border are repeated lines extending in the same direction, and less valid information is carried. If there are many internal conflicting line segments, i.e., if there are many contour line segments belonging to different target vanishing points, it indicates that most of lines included in the object plane corresponding to the structural border are lines extending in different directions, and more valid information may be carried. Therefore, the more the internal associated line segments, the greater the second evaluation value; and the more the internal conflicting line segments, the less the second evaluation value.

Step S211: performing weighting calculation on the first evaluation value and the second evaluation value to obtain the matching degree of the structural border.

Step S212: determining the target border based on the matching degree.

Further, exemplarily, the matching degree of the structural border may be obtained by performing weighting calculation on the first evaluation value and a plurality of second evaluation values described above. Weighting coefficients of the first evaluation value and each second evaluation value may be set particularly as required, which will not be specifically defined here.

In the present embodiment, the matching degree corresponding to the structural border is obtained by performing weighting calculation on the first evaluation value and the plurality of second evaluation values. Then, one of more structural borders are selected as the target border corresponding to the object plane most suitable for mounting the virtual effect. The accurate detection of the mounting plane is realized and the visual representation of the mounted virtual effect is improved.

Step S213: acquiring a preset camera focal length parameter, and obtaining a three-dimensional direction of the target border based on the camera focal length parameter and a target vanishing point corresponding to the target border, in which the three-dimensional direction is a normal direction of a plane corresponding to the target border.

Step S214: determining a mounting direction of the virtual effect according to the three-dimensional direction of the target border.

Exemplarily, further, after the target border is determined, the target border, as a two-dimensional border, may merely determine one two-dimensional plane. On this basis, the corresponding three-dimensional direction is added to the target border through the preset camera focal length parameter such that the mounting direction for mounting the virtual effect is determined.

Specifically, for example, the camera focal length parameter is denoted by f. The target vanishing points include a target horizontal vanishing point and a target vertical vanishing point. The target horizontal vanishing point is P1=(p1x, p1y). The target vertical vanishing point is P2=(p2x, p2y). The three-dimensional angle corresponding to P1 is P1_3d and the three-dimensional angle corresponding to P2 is P2_3d, which are respectively expressed as follows:

$$\begin{matrix}P1\_ 3 d = ( p 1 x , p 1 y , f ) / \vert ( p 1 x , p 1 y , f ) \vert \\ P2\_ 3 d = ( p 2 x , p 2 y , f ) / \vert ( p 2 x , p 2 y , f ) \vert .\end{matrix}$$

Then, the corresponding three-dimensional direction can be obtained by orthogonality restriction based on two three-dimensional directions obtained as above, and its process is the related art, which will not be described here redundantly.

In the present embodiment, the three-dimensional direction is added on the basis of the target border such that the mounting direction for mounting the virtual effect on the mounting plane is further determined. A display error caused by a wrong mounting direction is avoided, and the visual representation of the virtual effect is improved.

Corresponding to the method for detecting a virtual effect mounting plane in the foregoing embodiments, FIG. 10 is a structural block diagram of an apparatus for detecting a virtual effect mounting plane provided by the embodiments of the present disclosure. For ease of description, only the parts related to this embodiment of the present disclosure are illustrated. With FIG. 10, the apparatus 3 for detecting a virtual effect mounting plane includes:
an acquisition module 31, which is configured to acquire contour line segments, and obtain corresponding edge corner points based on the contour line segments, in which the contour line segments represent a contour of an object in an image to be detected, and the edge corner points are intersection points between the contour line segments;
a generation module 32, which is configured to generate at least two quadrilateral structural borders with the edge corner points, in which each of the structural borders represents a contour of a plane of an object in the image be detected; and
a detection module 33, which is configured to obtain matching degrees of the structural borders through target vanishing points corresponding to the structural borders, and determine a target border based on the matching degrees, in which an object plane corresponding to the target border is used for mounting a virtual effect, and each of the matching degrees represents a degree to which an object plane corresponding to a structural border is suitable for mounting a virtual effect.

In one embodiment of the present disclosure, the generation module 32 is specifically configured to:
acquire edge-corner structures corresponding to the edge corner points, in which each of the edge-corner structures includes two contour line segments constituting an edge corner point; obtain at least one edge-corner structure combination according to a positional relationship between the edge-corner structures corresponding to the edge corner points, in which the edge-corner structure combination includes at least one edge-corner structure, the at least one edge-corner structure in the edge-corner structure combination belongs to the same quadrilateral, and in response to the edge-corner structure combination including more than two edge-corner structures, at least one contour line segment of any edge-corner structure in the edge-corner structure combination partially overlaps with another edge-corner structure; and generate the structural borders according to the edge-corner structure combination.

In one embodiment of the present disclosure, the generation module 32, when generating the structural borders according to the edge-corner structure combination, is specifically configured to: acquire a horizontal vanishing point and a vertical vanishing point corresponding to each edge-corner structure in the edge-corner structure combination; generate a first relevant line segment corresponding to the horizontal vanishing point and a second relevant line segment corresponding to the vertical vanishing point, and form a structural border based on the first relevant line segment, the second relevant line segment, and the edge-corner structure, in which a first end of the first relevant line segment intersects with a first end of the second relevant line segment, a second end of the first relevant line segment intersects with an endpoint of one contour line segment, and a second end of the second relevant line segment intersects with an endpoint of another contour line segment.

In one embodiment of the present disclosure, the generation module 32, before generating the structural borders according to the edge-corner structure combination, is specifically configured to: acquire a total number of edge-corner structures comprised in each edge-corner structure combination; and determine an edge-corner structure combination with a total number of edge-corner structures greater than a preset number threshold as a target edge-corner structure combination. The generation module 32, when generating the structural borders according to the edge-corner structure combination, is specifically configured to generate the structural borders based on the edge-corner structures in the target edge-corner structure combination.

In one embodiment of the present disclosure, the detection module 33 is specifically configured to: acquire a first evaluation value of the structural border, in which the first evaluation value represents a total number of relevant line segments corresponding to the target vanishing point, and the relevant line segments are contour line segments belonging to the target vanishing point; and obtain the matching degree of the structural border according to the first evaluation value.

In one embodiment of the present disclosure, the detection module 33 is further configured to acquire a second evaluation value of the structural border, in which the second evaluation value represents a visual feature of an object plane corresponding to the structural border in the image to be detected. The detection module 33, when obtaining the matching degree of the structural border according to the first evaluation value, is specifically configured to perform weighting calculation on the first evaluation value and the second evaluation value to obtain the matching degree of the structural border.

In one embodiment of the present disclosure, the second evaluation value includes at least one selected from a group consisting of: a visual included angle, an image area, a total number of internal associated line segments, and a total number of internal conflicting line segments; the visual included angle is an included angle between the object plane corresponding to the structural border and a center line of a camera; the image area is an area of the object plane corresponding to the structural border in the image to be detected; the internal associated line segments are contour line segments located within the structural border and belonging to the target vanishing point corresponding to the structural border; and the internal conflicting line segments are contour line segments located within the structural border and not belonging to the target vanishing point corresponding to the structural border.

In one embodiment of the present disclosure, the generation module 32 is further configured to: obtain a plurality of candidate vanishing points through the contour line segments and the edge corner points, in which relevant line segments corresponding to the candidate vanishing points pass through the edge corner points; and determine corresponding target vanishing points according to the edge corner points corresponding to the structural borders.

In one embodiment of the present disclosure, the acquisition module 31 is specifically configured to: obtain at least two intersection corner points according to intersection relationships of the contour line segments; and perform clustering fusion on the intersection corner points based on a density clustering algorithm to generate the edge corner points.

In one embodiment of the present disclosure, the detection module 33 is further configured to: acquire a preset camera focal length parameter; obtain a three-dimensional direction of the target border based on the camera focal length parameter and a target vanishing point corresponding to the target border, in which the three-dimensional direction is a normal direction of a plane corresponding to the target border; and determine a mounting direction of the virtual effect according to the three-dimensional direction of the target border.

The acquisition module 31, the generation module 32, and the detection module 33 are connected in sequence. The apparatus 3 for detecting a virtual effect mounting plane provided by the present embodiment can perform the technical solutions of the above-mentioned method embodiments, and implementation principles and technical effects thereof are similar, which will not be described redundantly in the present embodiment.

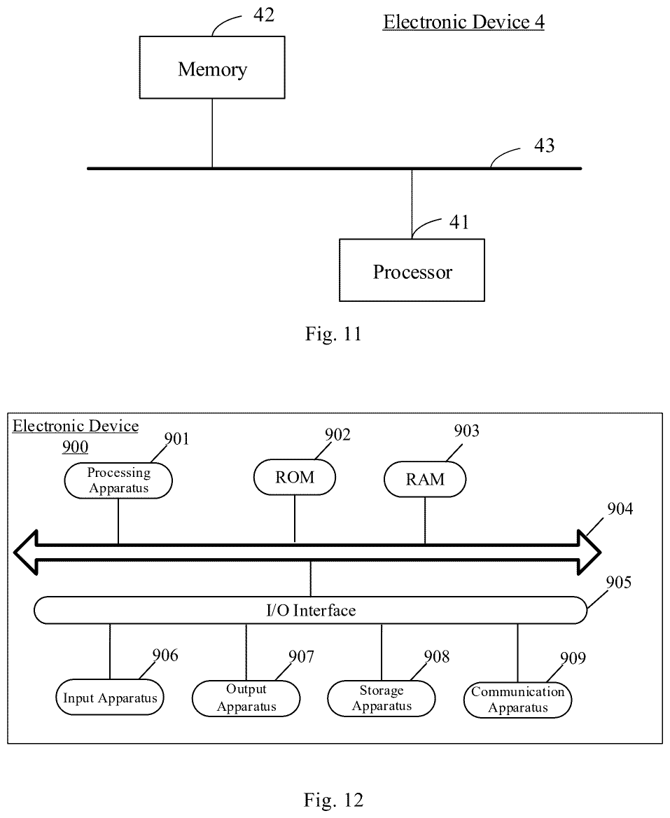

FIG. 11 is a schematic structural diagram of an electronic device provided by the embodiments of the present disclosure. As shown in FIG. 11, the electronic device 4 includes a processor 41, and a memory 42 in communication connection with the processor 41.

The memory 42 is configured to store computer-executable instructions.

The processor 41 is configured to execute the computer-executable instructions stored in the memory 42 to implement the method for detecting a virtual effect mounting plane in the embodiments shown in FIG. 2 to FIG. 9.

Optionally, the processor 41 and the memory 42 are connected through a bus 43.

For related descriptions, a reference may be made to the corresponding related descriptions and

effects of the steps in the embodiments shown in FIG. 2 to FIG. 9, which will not be described here redundantly.

Referring to FIG. 12, FIG. 12 illustrates a schematic structural diagram of an electronic device 900 suitable for implementing the embodiments of the present disclosure. The electronic device 900 may be a terminal device or a server. The terminal device may include but is not limited to a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and a fixed terminal such as a digital TV, a desktop computer, or the like. The electronic device illustrated in FIG. 12 is merely an example, and should not pose any limitation to the functions and the range of use of the embodiments of the present disclosure.

As illustrated in FIG. 12, the electronic device 900 may include a processing apparatus 901 (e.g., a central processing unit, a graphics processing unit, etc.), which can perform various suitable actions and processing according to a program stored in a read-only memory (ROM) 902 or a program loaded from a storage apparatus 908 into a random-access memory (RAM) 903. The RAM 903 further stores various programs and data required for operations of the electronic device 900. The processing apparatus 901, the ROM 902, and the RAM 903 are interconnected through a bus 904. An input/output (I/O) interface 905 is also connected to the bus 904.

Usually, the following apparatuses may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the electronic device 900 to be in wireless or wired communication with other devices to exchange data. While FIG. 12 illustrates the electronic device 900 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 909 and installed, or may be installed from the storage apparatus 908, or may be installed from the ROM 902. When the computer program is executed by the processing apparatus 901, the above-mentioned functions defined in the methods of the embodiments of the present disclosure are performed. The embodiments of the present disclosure further include a computer program, which, when executed by a processor, implements the above functions defined in the method of the embodiments of the present disclosure.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the methods illustrated in the above-mentioned embodiments.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit may also be described as a “unit for acquiring at least two Internet Protocol addresses.”

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

In a first aspect, one or more embodiments of the present disclosure provide a method for detecting a virtual effect mounting plane, which includes:
acquiring contour line segments, and obtaining corresponding edge corner points based on the contour line segments, in which the contour line segments represent a contour of an object in an image to be detected, and the edge corner points are intersection points between the contour line segments; generating at least two quadrilateral structural borders with the edge corner points, in which each of the structural borders represents a contour of a plane of an object in the image to be detected; and obtaining matching degrees of the structural borders through target vanishing points corresponding to the structural borders, and determining a target border based on the matching degrees, in which an object plane corresponding to the target border is used for mounting a virtual effect, and each of the matching degrees represents a degree to which an object plane corresponding to a structural border is suitable for mounting a virtual effect.

According to one or more embodiments of the present disclosure, the generating at least two quadrilateral structural borders with the edge corner points includes: acquiring edge-corner structures corresponding to the edge corner points, in which each of the edge-corner structures includes two contour line segments constituting an edge corner point; obtaining at least one edge-corner structure combination according to a positional relationship between the edge-corner structures corresponding to the edge corner points, in which the edge-corner structure combination includes at least one edge-corner structure, the at least one edge-corner structure in the edge-corner structure combination belongs to a same quadrilateral, and in response to the edge-corner structure combination including more than two edge-corner structures, at least one contour line segment of any edge-corner structure in the edge-corner structure combination partially overlaps with another edge-corner structure; and generating the structural borders according to the edge-corner structure combination.

According to one or more embodiments of the present disclosure, the generating the structural borders according to the edge-corner structure combination includes: acquiring a horizontal vanishing point and a vertical vanishing point corresponding to each edge-corner structure in the edge-corner structure combination; and generating a first relevant line segment corresponding to the horizontal vanishing point and a second relevant line segment corresponding to the vertical vanishing point, and forming a structural border based on the first relevant line segment, the second relevant line segment, and the edge-corner structure, in which a first end of the first relevant line segment intersects with a first end of the second relevant line segment, a second end of the first relevant line segment intersects with an endpoint of one contour line segment, and a second end of the second relevant line segment intersects with an endpoint of another contour line segment.

According to one or more embodiments of the present disclosure, before generating the structural borders according to the edge-corner structure combination, the method further includes: acquiring a total number of edge-corner structures included in each edge-corner structure combination; and determining an edge-corner structure combination with a total number of edge-corner structures greater than a preset number threshold as a target edge-corner structure combination; and the generating the structural borders according to the edge-corner structure combination includes: generating the structural borders based on edge-corner structures in the target edge-corner structure combination.

According to one or more embodiments of the present disclosure, the obtaining the matching degrees of the structural borders through the target vanishing points corresponding to the structural borders, includes: acquiring a first evaluation value of a structural border, in which the first evaluation value represents a total number of relevant line segments corresponding to a target vanishing point, and the relevant line segments are contour line segments belonging to the target vanishing point; and obtaining the matching degree of the structural border according to the first evaluation value.

According to one or more embodiments of the present disclosure, the method further includes: acquiring a second evaluation value of the structural border, in which the second evaluation value represents a visual feature of an object plane corresponding to the structural border in the image to be detected; and the obtaining the matching degree of the structural border according to the first evaluation value includes: performing weighting calculation on the first evaluation value and the second evaluation value to obtain the matching degree of the structural border.

According to one or more embodiments of the present disclosure, the second evaluation value includes at least one selected from a group consisting of: a visual included angle, an image area, a total number of internal associated line segments, and a total number of internal conflicting line segments; the visual included angle is an included angle between the object plane corresponding to the structural border and a center line of a camera; the image area is an area of the object plane corresponding to the structural border in the image to be detected; the internal associated line segments are contour line segments located within the structural border and belonging to the target vanishing point corresponding to the structural border; and the internal conflicting line segments are contour line segments located within the structural border and not belonging to the target vanishing point corresponding to the structural border.

According to one or more embodiments of the present disclosure, the method further includes: obtaining a plurality of candidate vanishing points through the contour line segments and the edge corner points, in which relevant line segments corresponding to the candidate vanishing points pass through the edge corner points; and determining corresponding target vanishing points according to the edge corner points corresponding to the structural borders.

According to one or more embodiments of the present disclosure, the obtaining corresponding edge corner points based on the contour line segments includes: obtaining at least two intersection corner points according to intersection relationships of the contour line segments; and performing clustering fusion on the intersection corner points based on a density clustering algorithm to generate the edge corner points.

According to one or more embodiments of the present disclosure, the method further includes: acquiring a preset camera focal length parameter; obtaining a three-dimensional direction of the target border based on the camera focal length parameter and a target vanishing point corresponding to the target border, in which the three-dimensional direction is a normal direction of a plane corresponding to the target border; and determining a mounting direction of the virtual effect according to the three-dimensional direction of the target border.

The structural borders are generated by detecting the edge corner points. The structural borders are screened with the vanishing points to determine the target border for locating the mounting plane. With the structural features of the object in the image in combination with the vanishing point, the obtained target border can accurately locate the object plane suitable for mounting the virtual effect in the image to be detected. Thus, the detection of the mounting plane is realized, and the detection accuracy of the mounting plane and the detection robustness in different image scenes are improved.

In a second aspect, one or more embodiments of the present disclosure provide an apparatus for detecting a virtual effect mounting plane, which includes:
an acquisition module, which is configured to acquire contour line segments, and obtain corresponding edge corner points based on the contour line segments, in which the contour line segments represent a contour of an object in an image to be detected, and the edge corner points are intersection points between the contour line segments;
a generation module, which is configured to generate at least two quadrilateral structural borders with the edge corner points, in which each of the structural borders represents a contour of a plane of an object in the image be detected; and
a detection module, which is configured to obtain matching degrees of the structural borders through target vanishing points corresponding to the structural borders, and determine a target border based on the matching degrees, in which an object plane corresponding to the target border is used for mounting a virtual effect, and each of the matching degrees represents a degree to which an object plane corresponding to a structural border is suitable for mounting a virtual effect.

According to one or more embodiments of the present disclosure, the generation module is specifically configured to: acquire edge-corner structures corresponding to the edge corner points, in which each of the edge-corner structures includes two contour line segments constituting an edge corner point; obtain at least one edge-corner structure combination according to a positional relationship between the edge-corner structures corresponding to the edge corner points, in which the edge-corner structure combination includes at least one edge-corner structure, the at least one edge-corner structure in the edge-corner structure combination belongs to the same quadrilateral, and in response to the edge-corner structure combination including more than two edge-corner structures, at least one contour line segment of any edge-corner structure in the edge-corner structure combination partially overlaps with another edge-corner structure; and generate the structural borders according to the edge-corner structure combination.

According to one or more embodiments of the present disclosure, the generation module, when generating the structural borders according to the edge-corner structure combination, is specifically configured to: acquire a horizontal vanishing point and a vertical vanishing point corresponding to each edge-corner structure in the edge-corner structure combination; generate a first relevant line segment corresponding to the horizontal vanishing point and a second relevant line segment corresponding to the vertical vanishing point, and form a structural border based on the first relevant line segment, the second relevant line segment, and the edge-corner structure, in which a first end of the first relevant line segment intersects with a first end of the second relevant line segment, a second end of the first relevant line segment intersects with an endpoint of one contour line segment, and a second end of the second relevant line segment intersects with an endpoint of another contour line segment.

According to one or more embodiments of the present disclosure, the generation module, before generating the structural borders according to the edge-corner structure combination, is specifically configured to: acquire a total number of edge-corner structures comprised in each edge-corner structure combination; and determine an edge-corner structure combination with a total number of edge-corner structures greater than a preset number threshold as a target edge-corner structure combination. The generation module 32, when generating the structural borders according to the edge-corner structure combination, is specifically configured to generate the structural borders based on the edge-corner structures in the target edge-corner structure combination.

According to one or more embodiments of the present disclosure, the detection module is specifically configured to: acquire a first evaluation value of the structural border, in which the first evaluation value represents a total number of relevant line segments corresponding to the target vanishing point, and the relevant line segments are contour line segments belonging to the target vanishing point; and obtain the matching degree of the structural border according to the first evaluation value.

According to one or more embodiments of the present disclosure, the detection module is further configured to acquire a second evaluation value of the structural border, in which the second evaluation value represents a visual feature of an object plane corresponding to the structural border in the image to be detected. The detection module 33, when obtaining the matching degree of the structural border according to the first evaluation value, is specifically configured to perform weighting calculation on the first evaluation value and the second evaluation value to obtain the matching degree of the structural border.

According to one or more embodiments of the present disclosure, the second evaluation value includes at least one selected from a group consisting of: a visual included angle, an image area, a total number of internal associated line segments, and a total number of internal conflicting line segments; the visual included angle is an included angle between the object plane corresponding to the structural border and a center line of a camera; the image area is an area of the object plane corresponding to the structural border in the image to be detected; the internal associated line segments are contour line segments located within the structural border and belonging to the target vanishing point corresponding to the structural border; and the internal conflicting line segments are contour line segments located within the structural border and not belonging to the target vanishing point corresponding to the structural border.

According to one or more embodiments of the present disclosure, the generation module is further configured to: obtain a plurality of candidate vanishing points through the contour line segments and the edge corner points, in which relevant line segments corresponding to the candidate vanishing points pass through the edge corner points; and determine corresponding target vanishing points according to the edge corner points corresponding to the structural borders.

According to one or more embodiments of the present disclosure, the acquisition module is specifically configured to: obtain at least two intersection corner points according to intersection relationships of the contour line segments; and perform clustering fusion on the intersection corner points based on a density clustering algorithm to generate the edge corner points.

According to one or more embodiments of the present disclosure, the detection module is further configured to: acquire a preset camera focal length parameter; obtain a three-dimensional direction of the target border based on the camera focal length parameter and a target vanishing point corresponding to the target border, in which the three-dimensional direction is a normal direction of a plane corresponding to the target border; and determine a mounting direction of the virtual effect according to the three-dimensional direction of the target border.

In a third aspect, one or more embodiments of the present disclosure provide an electronic device, which includes a processor and a memory in communication connection with the processor,
the memory is configured to store computer-executable instructions; and
the processor is configured to execute the computer-executable instructions stored in the memory to implement the method for detecting a virtual effect mounting plane according to the first aspect or any embodiment in the first aspect.

In a fourth aspect, one or more embodiments of the present disclosure provide a computer-readable storage medium, which stores computer-executable instructions, and a processor, when executing the computer-executable instructions, implements the method for detecting a virtual effect mounting plane according to the first aspect or any embodiment in the first aspect.

In a fifth aspect, the embodiments of the present disclosure further provide a computer program product, which includes a computer program, and the computer program, when executed by a processor, implements the method for detecting a virtual effect mounting plane according to the first aspect or any embodiment in the first aspect.

In a sixth aspect, the embodiments of the present disclosure further provide a computer program, which is configured to implement the method for detecting a virtual effect mounting plane according to the first aspect or any embodiment in the first aspect. The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A method for detecting a virtual effect mounting plane, comprising:
acquiring contour line segments, and obtaining corresponding edge corner points based on the contour line segments, wherein the contour line segments represent a contour of an object in an image to be detected, and the edge corner points are intersection points between the contour line segments;
generating at least two quadrilateral structural borders with the edge corner points, wherein each of the structural borders represents a contour of a plane of an object in the image to be detected; and
obtaining matching degrees of the structural borders through target vanishing points corresponding to the structural borders, and determining a target border based on the matching degrees, wherein an object plane corresponding to the target border is used for mounting a virtual effect, and each of the matching degrees represents a degree to which an object plane corresponding to a structural border among the structural borders is suitable for mounting a virtual effect.

2. The method according to claim 1, wherein the generating at least two quadrilateral structural borders with the edge corner points comprises:
acquiring edge-corner structures corresponding to the edge corner points, wherein each of the edge-corner structures comprises two contour line segments constituting an edge corner point among the edge corner points;
obtaining at least one edge-corner structure combination according to a positional relationship between the edge-corner structures corresponding to the edge corner points, wherein the edge-corner structure combination comprises at least one edge-corner structure, the at least one edge-corner structure in the edge-corner structure combination belongs to a same quadrilateral, and in response to the edge-corner structure combination comprising more than two edge-corner structures, at least one contour line segment of any edge-corner structure in the edge-corner structure combination partially overlaps with another edge-corner structure; and
generating the structural borders according to the edge-corner structure combination.

3. The method according to claim 2, wherein the generating the structural borders according to the edge-corner structure combination comprises:
acquiring a horizontal vanishing point and a vertical vanishing point corresponding to each edge-corner structure in the edge-corner structure combination; and
generating a first relevant line segment corresponding to the horizontal vanishing point and a second relevant line segment corresponding to the vertical vanishing point, and forming a structural border based on the first relevant line segment, the second relevant line segment, and the edge-corner structure, wherein a first end of the first relevant line segment intersects with a first end of the second relevant line segment, a second end of the first relevant line segment intersects with an endpoint of one contour line segment, and a second end of the second relevant line segment intersects with an endpoint of another contour line segment.

4. The method according to claim 2, before generating the structural borders according to the edge-corner structure combination, further comprising:
acquiring a total number of edge-corner structures comprised in each edge-corner structure combination; and
determining an edge-corner structure combination with a total number of edge-corner structures greater than a preset number threshold as a target edge-corner structure combination; and
the generating the structural borders according to the edge-corner structure combination comprises:
generating the structural borders based on edge-corner structures in the target edge-corner structure combination.

5. The method according to claim 1, wherein the obtaining the matching degrees of the structural borders through the target vanishing points corresponding to the structural borders, comprises:
acquiring a first evaluation value of a structural border among the structural borders, wherein the first evaluation value represents a total number of relevant line segments corresponding to a target vanishing point corresponding to the structural border, and the relevant line segments are contour line segments belonging to the target vanishing point; and
obtaining the matching degree of the structural border according to the first evaluation value.

6. The method according to claim 5, further comprising:
acquiring a second evaluation value of the structural border, wherein the second evaluation value represents a visual feature of an object plane corresponding to the structural border in the image to be detected; and
the obtaining the matching degree of the structural border according to the first evaluation value comprises:
performing weighting calculation on the first evaluation value and the second evaluation value to obtain the matching degree of the structural border.

7. The method according to claim 6, wherein the second evaluation value comprises at least one selected from a group consisting of:
a visual included angle, an image area, a total number of internal associated line segments, and a total number of internal conflicting line segments,
wherein the visual included angle is an included angle between the object plane corresponding to the structural border and a center line of a camera;
the image area is an area of the object plane corresponding to the structural border in the image to be detected;
the internal associated line segments are contour line segments located within the structural border and belonging to the target vanishing point corresponding to the structural border; and
the internal conflicting line segments are contour line segments located within the structural border and not belonging to the target vanishing point corresponding to the structural border.

8. The method according to claim 1, further comprising:
obtaining a plurality of candidate vanishing points through the contour line segments and the edge corner points, wherein relevant line segments corresponding to the candidate vanishing points pass through the edge corner points; and
determining corresponding target vanishing points according to the edge corner points corresponding to the structural borders.

9. The method according to claim 1, wherein the obtaining corresponding edge corner points based on the contour line segments comprises:
obtaining at least two intersection corner points according to intersection relationships of the contour line segments; and
performing clustering fusion on the intersection corner points based on a density clustering algorithm to generate the edge corner points.

10. The method according to claim 1, further comprising:
acquiring a preset camera focal length parameter;
obtaining a three-dimensional direction of the target border based on the camera focal length parameter and a target vanishing point corresponding to the target border, wherein the three-dimensional direction is a normal direction of a plane corresponding to the target border; and
determining a mounting direction of the virtual effect according to the three-dimensional direction of the target border.

11. (canceled)

12. An electronic device, comprising a processor and a memory in communication connection with the processor,
wherein the memory is configured to store computer-executable instructions; and
the processor is configured to execute the computer-executable instructions stored in the memory to implement a method for detecting a virtual effect mounting plane, which comprises:
acquiring contour line segments, and obtaining corresponding edge corner points based on the contour line segments, wherein the contour line segments represent a contour of an object in an image to be detected, and the edge corner points are intersection points between the contour line segments;
generating at least two quadrilateral structural borders with the edge corner points, wherein each of the structural borders represents a contour of a plane of an object in the image to be detected; and
obtaining matching degrees of the structural borders through target vanishing points corresponding to the structural borders, and determining a target border based on the matching degrees, wherein an object plane corresponding to the target border is used for mounting a virtual effect, and each of the matching degrees represents a degree to which an object plane corresponding to a structural border among the structural borders is suitable for mounting a virtual effect.

13. A non-transitory computer-readable storage medium, storing computer-executable instructions, wherein a processor, when executing the computer-executable instructions, implements a method for detecting a virtual effect mounting plane, which comprises:
acquiring contour line segments, and obtaining corresponding edge corner points based on the contour line segments, wherein the contour line segments represent a contour of an object in an image to be detected, and the edge corner points are intersection points between the contour line segments;
generating at least two quadrilateral structural borders with the edge corner points, wherein each of the structural borders represents a contour of a plane of an object in the image to be detected; and
obtaining matching degrees of the structural borders through target vanishing points corresponding to the structural borders, and determining a target border based on the matching degrees, wherein an object plane corresponding to the target border is used for mounting a virtual effect, and each of the matching degrees represents a degree to which an object plane corresponding to a structural border among the structural borders is suitable for mounting a virtual effect.

14-15. (canceled)

16. The method according to claim 3, before generating the structural borders according to the edge-corner structure combination, further comprising:
acquiring a total number of edge-corner structures comprised in each edge-corner structure combination; and
determining an edge-corner structure combination with a total number of edge-corner structures greater than a preset number threshold as a target edge-corner structure combination; and
the generating the structural borders according to the edge-corner structure combination comprises:
generating the structural borders based on edge-corner structures in the target edge-corner structure combination.

17. The method according to claim 2, wherein the obtaining the matching degrees of the structural borders through the target vanishing points corresponding to the structural borders, comprises:
acquiring a first evaluation value of a structural border among the structural borders, wherein the first evaluation value represents a total number of relevant line segments corresponding to a target vanishing point corresponding to the structural border, and the relevant line segments are contour line segments belonging to the target vanishing point; and
obtaining the matching degree of the structural border according to the first evaluation value.

18. The method according to claim 3, wherein the obtaining the matching degrees of the structural borders through the target vanishing points corresponding to the structural borders, comprises:
acquiring a first evaluation value of a structural border among the structural borders, wherein the first evaluation value represents a total number of relevant line segments corresponding to a target vanishing point corresponding to the structural border, and the relevant line segments are contour line segments belonging to the target vanishing point; and
obtaining the matching degree of the structural border according to the first evaluation value.

19. The method according to claim 4, wherein the obtaining the matching degrees of the structural borders through the target vanishing points corresponding to the structural borders, comprises:
acquiring a first evaluation value of a structural border among the structural borders, wherein the first evaluation value represents a total number of relevant line segments corresponding to a target vanishing point corresponding to the structural border, and the relevant line segments are contour line segments belonging to the target vanishing point; and
obtaining the matching degree of the structural border according to the first evaluation value.

20. The method according to claim 2, further comprising:
obtaining a plurality of candidate vanishing points through the contour line segments and the edge corner points, wherein relevant line segments corresponding to the candidate vanishing points pass through the edge corner points; and
determining corresponding target vanishing points according to the edge corner points corresponding to the structural borders.

21. The method according to claim 3, further comprising:
obtaining a plurality of candidate vanishing points through the contour line segments and the edge corner points, wherein relevant line segments corresponding to the candidate vanishing points pass through the edge corner points; and
determining corresponding target vanishing points according to the edge corner points corresponding to the structural borders.

22. The method according to claim 4, further comprising:
obtaining a plurality of candidate vanishing points through the contour line segments and the edge corner points, wherein relevant line segments corresponding to the candidate vanishing points pass through the edge corner points; and
determining corresponding target vanishing points according to the edge corner points corresponding to the structural borders.

23. The method according to claim 5, further comprising:
obtaining a plurality of candidate vanishing points through the contour line segments and the edge corner points, wherein relevant line segments corresponding to the candidate vanishing points pass through the edge corner points; and
determining corresponding target vanishing points according to the edge corner points corresponding to the structural borders.
